(19) United States
(12) Patent Application Publication
(10) Pub. No.: US 2024/0359129 A1
(43) Pub. Date: Oct. 31, 2024

(54) APPARATUS AND METHOD FOR ABSORBING, CAPTURING, AND DESORBING CARBON DIOXIDE USING SOLID AMINES

(71) Applicant: BEIJING DERUNCHEN ENVIRONMENTAL PROTECTION TECHNOLOGY CO., LTD, Beijing (CN)

(72) Inventors: Feng QIU, Beijing (CN); Yingju LIU, Beijing (CN); Tianlei YANG, Beijing (CN)

(73) Assignee: BEIJING DERUNCHEN ENVIRONMENTAL PROTECTION TECHNOLOGY CO., LTD, Beijing (CN)

(21) Appl. No.: 18/687,004

(22) PCT Filed: Jul. 28, 2022
(86) PCT No.: PCT/CN2022/108468

§ 371 Date: Feb. 27, 2024

(30) Foreign Application Priority Data
Aug. 30, 2021 (CN) 202111007181.7

(51) Int. Cl. B01D 53/04

(52) U.S. Cl. CPC B01D 53/0454; B01D 53/0438; B01D 2253/20; B01D 2257/504

(57) ABSTRACT

Provided herein is an apparatus for absorbing, capturing, and desorbing CO₂ using solid amines, the apparatus comprising: a catcher used for capturing CO₂ in flue gas and comprising a treatment chamber and a delivery pipe for adsorption of CO₂ in the flue gas by means of a spherical solid amine adsorbent, the bottom end of the delivery pipe being provided with a flue gas inlet, a first solid amine inlet, and an adsorbent inlet; a desorber for heating and desorbing CO₂ adsorbed by the solid amine adsorbent; and a cooler for cooling the solid amine adsorbent from the desorber. Also provided is a method for absorbing, capturing and desorbing CO₂ using solid amine. The present invention realizes continuous operation of capture and desorption and can be used for capturing CO₂ in large-scale industrial flue gas.

### CROSS-REFERENCE TO RELATED APPLICATIONS

This application is the National Phase of International Application No. PCT/CN2022/108468, filed on Jul. 28, 2022, which claims the priority to Chinese Patent Application No. 202111007181.7, filed on Aug. 30, 2021, with the China National Intellectual Property Administration, the entire contents of which are incorporated into this application by reference.

### TECHNICAL FIELD

The invention relates to the technical field of atmospheric treatment and resource utilization in environmental protection, in particular to an apparatus and a method for absorbing, capturing and desorbing CO₂ using solid amine.

### BACKGROUND

Since the industrialization era, large amounts of CO₂ emissions have increased the concentration of CO₂ in the atmosphere, leading to a series of ecological problems such as the intensification of the greenhouse effect.

At present, there are three ways to reduce CO₂ emission. One is to adopt new low-carbon technology to replace old high-carbon technology; the second is to adopt zero-emission new technologies such as wind power generation and photovoltaic power generation; the third is carbon capture. Among them, the first two ways need to invest a lot of money and a long time to build new projects, which have better future prospects, but for solving the carbon emission problem of existing projects in the near future, “carbon capture” is the most effective method.

At present, capture of CO₂ comprises ethanolamine absorption and capture method and solid amine absorption and capture method. Among them, the solid amine absorption and capture method is more widely used because its lower energy consumption is much lower than ethanolamine method.

Specifically, the solid amine absorption and capturing method is a method that uses amine solid adsorbent to absorb CO₂ in flue gas at a lower temperature (30° C. to 50° C.) and then desorb CO₂ at a higher temperature (80° C. to 110° C.), that is, it is a dry adsorption and desorption process in which there is no participation of water and other solvents and the heat is only provided to the material itself, so the energy consumption is very low.

However, at present, what is put into application is fixed bed solid amine absorption and capture, which has good application effect in small-scale occasions. However, there are the following problems in capture of CO₂ in large-scale industrial flue gas: the continuous operation of adsorption and desorption processes cannot be realized, the fixed investment is high, the occupied area is large, the desorption and cooling process takes a long time, the equipment efficiency is low, the equipment volume is large, and the purity of CO₂ in desorption process is low due to the introduction of desorbed impurities, which increases the difficulty and cost of liquefaction and purification of CO₂.

Therefore, how to provide an apparatus for absorbing, capturing and desorbing CO₂ using solid amine and to realize the cyclic operation of adsorption and desorption, is a problem urgently to be solved by those skilled in the art.

### SUMMARY

In view of this, an apparatus for absorbing, capturing and desorbing CO₂ using solid amine is provided according to present invention to realize the cyclic operation of adsorption and desorption. In addition, a method for absorbing, capturing and desorbing CO₂ using solid amine is also provided according to present invention.

In order to achieve the above-mentioned objects, the following technical solutions are provided according to the present invention:

An apparatus for absorbing, capturing and desorbing CO₂ using solid amine, comprising:
a catcher used for capturing CO₂ in flue gas and comprising a treatment chamber for adsorbing CO₂ in flue gas by means of a spherical solid amine adsorbent and a delivery pipe communicated with the treatment chamber, a bottom end of the delivery pipe being provided with a flue gas inlet, a first solid amine inlet and an adsorbent inlet, and an adsorbent outlet of the treatment chamber being communicated with the adsorbent inlet;
a desorber for desorbing CO₂ adsorbed by the solid amine adsorbent, a second solid amine inlet of the desorber being communicated with a first solid amine outlet of the catcher; and
a cooler for cooling the solid amine adsorbent treated by the desorber, a third solid amine inlet of the cooler being communicated with a second solid amine outlet of the desorber, and a third solid amine outlet of the cooler being communicated with the first solid amine inlet of the catcher.

Preferably, in the above-mentioned apparatus for absorbing, capturing and desorbing CO₂ using solid amine, in the delivery pipe, a temperature is 30° C. to 40° C., a pressure is 70 kPa(a) to 120 kPa(a), a solid-gas ratio is 2 to 30, a gas flow rate is 2 m/s to 20 m/s, and a contact time of the flue gas being mixed with the solid amine adsorbent is 3 s to 20 s.

Preferably, in the above-mentioned apparatus for absorbing, capturing and desorbing CO₂ using solid amine, the treatment chamber comprises the follow sections along the delivery direction of materials in the delivery pipe in sequence:
a collecting dense phase section provided with an air inlet for fluidizing air to enter and a distribution loop pipe communicated with the air inlet, the distribution loop pipe being uniformly provided with air outlets in a circumferential direction, and the first solid amine outlet and the adsorbent outlet being provided on the collecting dense phase section and below the distribution loop pipe and the air inlet;
a settling section communicated with the collecting dense phase section and used for settling the solid amine adsorbent for capturing CO₂; a top end of the delivery pipe being provided with a primary separator for separating the flue gas from the solid amine adsorbent, an outlet of the primary separator being located at the settling section, and the settling section being provided with a flue gas cyclone separator for separating flue gas treated by the primary separator, and a top of the settling section being provided with an exhaust port for discharging the treated flue gas

Preferably, in the above-mentioned apparatus for absorbing, capturing and desorbing CO₂ using solid amine, a cross-sectional area of the settling section is 2-10 times that of the collecting dense phase section, and the settling section and the collecting dense phase section are connected by an inclined section tapering from the settling section to the collecting dense phase section.

Preferably, in the above-mentioned apparatus for absorbing, capturing and desorbing CO₂ using solid amine, the adsorbent outlet is communicated with the adsorbent inlet through a circulating pipe, and the circulating pipe is provided with a circulating pipe slide valve for controlling the on-off of the circulating pipe.

Preferably, in the above-mentioned apparatus for absorbing, capturing and desorbing CO₂ using solid amine, the desorber comprises:
a desorber housing provided with the second solid amine inlet and the second solid amine outlet;
a heat exchanger provided in the desorber housing and used for heating and desorbing the solid amine adsorbent adsorbed with CO₂;
a desorber cyclone separator provided in the desorber housing and used for gas-solid separation.

Preferably, in the above-mentioned apparatus for absorbing, capturing and desorbing CO₂ using solid amine, the heat exchanger comprises:
a serpentine heating coil provided in the desorber housing;
a steam inlet and a condensing water drain outlet provided on the desorber housing and communicated with the serpentine heating coil, and the height of the steam inlet being higher than that of the condensing water drain outlet.

Preferably, in the above-mentioned apparatus for absorbing, capturing and desorbing CO₂ using solid amine, the desorber is a bubbling bed, and the desorber housing is provided with a CO₂ inlet for supplying CO₂ into the desorber housing and a CO₂ distributor for distributing the supplied CO₂, and the CO₂ inlet is communicated with the CO₂ distributor.

Preferably, in the above-mentioned apparatus for absorbing, capturing and desorbing CO₂ using solid amine, the second solid amine inlet is communicated with the first solid amine outlet through an upper connecting pipe provided with an upper slide valve for controlling the on-off of the upper connecting pipe, and a height of the first solid amine outlet is higher than that of the second solid amine inlet, and a height of the second solid amine inlet is higher than that of the second solid amine outlet;
a height of the desorber is higher than that of the collecting dense phase section and lower than that of the settling section.

Preferably, in the above-mentioned apparatus for absorbing, capturing and desorbing CO₂ using solid amine, the cooler comprises:
a cooler housing provided with the third solid amine inlet and the third solid amine outlet, and a top of the cooler housing being provided with an exhaust pipe communicated with an exhaust port of the settling section;
a serpentine cooling pipe provided in the cooler housing, the cooler housing being provided with a cooling water outlet and a cooling water inlet communicated with the serpentine cooling pipe, and a height of the cooling water inlet is lower than that of the cooling water outlet.

Preferably, in the above-mentioned apparatus for absorbing, capturing and desorbing CO₂ using solid amine, the cooler further comprises:
an air inlet provided on the cooler housing and used for supplying air into the cooler housing;
an air distribution pipe communicated with the air inlet, the air distribution pipe being an annular pipe arranged along a circumferential direction of the cooler housing, and the annular pipe being uniformly provided with air outlets.

Preferably, in the above-mentioned apparatus for absorbing, capturing and desorbing CO₂ using solid amine, the third solid amine outlet of the cooler is communicated with the first solid amine inlet through a connecting pipe provided with a connecting pipe slide valve for controlling the on-off of the connecting pipe, and a height of the third solid amine outlet is greater than that of the first solid amine inlet;
the third solid amine inlet of the cooler is communicated with the second solid amine outlet through a lower connecting pipe, and a height of the second solid amine outlet is greater than that of the third solid amine inlet, and a height of the third solid amine inlet is higher than that of the serpentine cooling pipe, and a height of the third outlet is lower than that of the serpentine cooling pipe.

Preferably, in the above-mentioned apparatus for absorbing, capturing and desorbing CO₂ using solid amine, a height of the cooler is lower than that of the desorber.

A method for absorbing, capturing and desorbing CO₂ using solid amine, comprising the following steps:
adsorption and capture of CO₂: introducing a flue gas into a delivery pipe using a fan, and fluidizing spherical solid amine adsorbent in the delivery pipe, wherein in the delivery pipe, a temperature is 30° C. to 40° C., a pressure is 70 kPa(a) to 120 kPa(a), a solid-gas ratio is 2 to 30, a gas flow rate is 2 m/s to 20 m/s, and a contact time of the flue gas being mixed with the solid amine adsorbent is 3 s to 20 s, to complete adsorption and capture of CO₂;
solid-gas separation: delivering the solid amine adsorbent adsorbed and captured with CO₂ to a top end of the delivery pipe, and completing gas-solid separation in a flue gas cyclone separator in a settling chamber at a top end of the delivery pipe, discharging the gas through an exhaust port, the solid amine adsorbent settling to a collecting dense phase section, and delivering a part of the solid amine adsorbent to the delivery pipe to enter the next cycle;
desorption of CO₂: delivering the settled solid amine adsorbent to a desorber by gravity, introducing CO₂ desorbed last time into the desorber as a fluidizing agent for fluidizing the solid amine adsorbent, and heating the solid amine adsorbent using a heat exchanger of a bubbling bed, and when the solid amine adsorbent is heated to 80° C. to 110° C. and desorbed for 3 min to 10 min, desorbing CO₂ from the spherical adsorbent; and
cooling of the solid amine adsorbent: delivering the desorbed high-temperature solid amine adsorbent from the desorber to the cooler by gravity, and fluidizing by air and cooling for 5 min to 30 min through a serpentine cooling pipe to obtain a solid amine adsorbent at 40° C., and delivering the solid amine adsorbent to the delivery pipe to enter the next cycle.

An apparatus for absorbing, capturing and desorbing CO₂ using solid amine is provided according to the invention, in which CO₂ is absorbed and captured by using solid amine adsorbent to reduce the content of CO₂ in flue gas to be treated, ensuring emission safety. In addition, the solid amine adsorbent adsorbed and captured with CO₂ is desorbed from CO₂, and the desorbed CO₂ can produce CO₂ products, and the desorbed solid amine adsorbent can be reused. Through the above, the continuous operation of capture and desorption is realized, which can be used for capturing CO₂ in large-scale industrial flue gas. In addition, the equipment is of simple structure, high stability and high operation flexibility; the desorption heat consumption is small, the production cost is low, and there is no discharge of waste water and waste liquid.

In addition, a method for absorbing, capturing and desorbing CO₂ using solid amine is also provided according to the invention to realizes continuous operation of capture and desorption and can be used for capturing CO₂ in large-scale industrial flue gas.

### BRIEF DESCRIPTION OF THE DRAWINGS

For more clearly illustrating embodiments of the present invention or technical solutions in the conventional technology, the drawing used in describing the embodiments or the conventional technology will be briefly described hereinafter. Apparently, the drawings in the following description are only some embodiments of the present application, and for those skilled in the art, other drawings may be obtained based on the provided drawing without any creative efforts.

FIG. 1 is a schematic structural diagram of an apparatus for absorbing, capturing and desorbing CO₂ using solid amine disclosed in an embodiment of the present invention;

FIG. 2 is a flowchart of a method for absorbing, capturing and desorbing CO₂ using solid amine disclosed in an embodiment of the present invention.

### DETAILED DESCRIPTION OF EMBODIMENTS

An apparatus for absorbing, capturing and desorbing CO₂ using solid amine is disclosed in the invention to realize the cyclic operation of adsorption and desorption. In addition, a method for absorbing, capturing and desorbing CO₂ using solid amine is also disclosed in the invention.

Technical solutions of embodiments of the present invention will be clearly and completely described hereinafter in conjunction with the drawings of the embodiments of the present invention. Apparently, the embodiments described are only some embodiments of the present invention, rather than all embodiments. Based on the embodiments in the present invention, all of the other embodiments which are obtained by those skilled in the art without any creative work fall within the protection scope of the present invention.

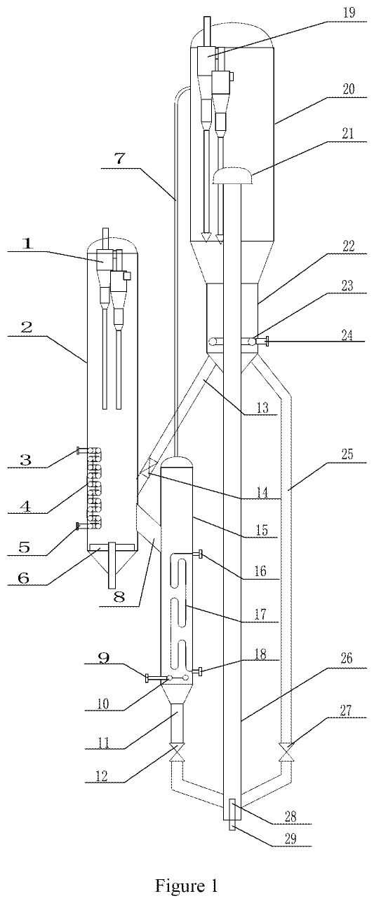

As shown in FIG. 1, an apparatus for absorbing, capturing and desorbing CO₂ using solid amine including a catcher, a desorber 2 and a cooler 15 is disclosed in the application. The above-mentioned catcher is used for capturing CO₂ in flue gas. Specifically, the catcher comprises a treatment chamber for adsorbing CO₂ in flue gas by spherical solid amine adsorbent and a delivery pipe 26 communicated with the treatment chamber. A bottom end of the delivery pipe 26 is provided with a flue gas inlet 29, a first solid amine inlet and an adsorbent inlet, and an adsorbent outlet of the above-mentioned treatment chamber is communicated with the adsorbent inlet. During operation, the flue gas to be treated enters the delivery pipe 26 through the flue gas inlet 29, at the same time, the solid amine adsorbent at about 40° C. enters the delivery pipe 26 through the first solid amine inlet, while the solid amine adsorbent at 50° C. to 60° C. enters the delivery pipe 26 through the adsorbent inlet, and the flue gas to be treated, the solid amine adsorbent at about 40° C. and the solid amine adsorbent at 50° C. to 60° C. are mixed in the delivery pipe 26, and delivered to the treatment room for absorption and capture of CO₂.

The above-mentioned desorber 2 is used for heating and desorbing CO₂ adsorbed by the solid amine adsorbent. Specifically, a second solid amine inlet of the desorber 2 is communicated with a first solid amine outlet of the catcher, that is, a part of the solid amine adsorbent after capturing CO₂ in the catcher enters the desorber 2, and the CO₂ is desorbed by heating treatment in the desorber 2.

In addition, the above-mentioned cooler 15 is used to cool the solid amine adsorbent treated by the desorber 2. Specifically, a third solid amine inlet of the cooler 15 is communicated with a second solid amine outlet of the desorber 2, and a third solid amine outlet of the cooler 15 is communicated with the first solid amine inlet of the catcher. During operation, the temperature of the solid amine adsorbent desorbed by the desorber 2 is higher, so it needs to be cooled for reuse. Therefore, the third solid amine inlet of the cooler 15 is communicated with the second solid amine outlet of the desorber 2, so that the solid amine adsorbent in the desorber 2 enters the cooler 15, and the solid amine adsorbent treated by the cooler 15 enters the first solid amine inlet of the catcher through the third solid amine outlet, thus realizing the reuse of the solid amine adsorbent.

In addition, the adsorbent outlet of the above-mentioned treatment chamber is communicated with the adsorbent inlet, that is, the other part of the solid amine adsorbent that has completed the adsorption and capture of CO₂ is returned from the treatment chamber to the adsorbent inlet for reuse, realizing the reuse of the solid amine adsorbent. It should be noted that the solid amine adsorbent involved in this application is divided into solid amine adsorbent with a temperature of 50° C. to 60° C. and solid amine adsorbent with a temperature of about 40° C., and the solid amine adsorbent that has completed the adsorption and capture passes through different pipelines and finally solid amine adsorbent at different temperatures is obtained.

It can be seen from the above-mentioned arrangement that in this application, CO₂ is adsorbed and captured using the solid amine adsorbent to reduce the content of CO₂ in the flue gas to be treated, ensuring the emission safety. In addition, the solid amine adsorbent adsorbed and captured with CO₂ is desorbed from CO₂, and the desorbed CO₂ can produce products of CO₂, and the desorbed solid amine adsorbent can be reused. Through the above, a continuous operation of capture and desorption is realized, which can be used for capturing CO₂ in large-scale industrial flue gas. In addition, the equipment is of simple structure, high stability and high operation flexibility; the desorption heat consumption is small, the production cost is low, and there is no discharge of waste water and waste liquid.

In a specific embodiment, in the above-mentioned delivery pipe 26, a temperature is 30° C. to 40° C., a pressure is 70 kPa(a) to 120 kPa(a), a solid-gas ratio is 2 to 30, a gas flow rate is 2 m/s to 20 m/s, and a contact time of the flue gas being mixed with the solid amine adsorbent is 3 s to 20 s. During operation, spherical solid amine adsorbent is used to fully mix and contact with flue gas in the delivery pipe 26, in which the temperature is 30° C. to 40° C., the pressure is 70 kPa(a) to 120 kPa(a), the solid-gas ratio is 2 to 30, and the gas flow rate is 2 m/s to 20 m/s, for 3 s to 20 s. After sufficient mass transfer and heat transfer, 60 g to 100 g of CO₂ is captured per kilogram of spherical solid amine adsorbent, and the spherical solid amine adsorbent is delivered to a high position. The specific temperature, pressure and flow rate during operation are defined here. In practice, other parameters can be selected according to different needs, and are not defined in detail here.

In addition, flue gas and spherical solid amine adsorbent flow in the delivery pipe 26 in the form of delivery bed, which is of high mass transfer speed, high capture efficiency of CO₂, stable operation, no problems such as partial flow and channeling, and is especially suitable for industrial flue gas with low pressure and stable requirements.

The treatment chamber disclosed in this application comprises a collecting dense phase section 22 and a settling section 20 along the delivery direction of materials in the delivery pipe 26 in sequence. The dense collecting phase section 22 is provided with an air inlet 24 for fluidizing air to enter and a distribution ring pipe 23 communicated with the air inlet 24, in which the distribution loop pipe 23 is uniformly provided with air outlets in the circumferential direction, and the first solid amine outlet and the adsorbent outlet are provided on the collecting dense phase section 22 and below the distribution loop pipe 23 and the air inlet 24. The above-mentioned settling section 20 is communicated with the collecting dense phase section 22 for the settling of solid amine adsorbent for capturing CO₂, and a top end of the delivery pipe 26 is provided with a primary separator 21 for separating flue gas from solid amine, and an outlet of the primary separator 21 is located at the settling section 20, and a flue gas cyclone separator 19 for separating flue gas treated by the primary separator 21 is provided in the settling section 20, and a top of the settling section 20 is provided with an exhaust port for discharging the treated flue gas.

During operation, the flue gas delivered by the delivery pipe 26 is mixed and fully contacted with the solid amine adsorbent, and then the solid amine adsorbent and the flue gas are preliminarily separated through the primary separator 21, and the separated gas further enters the flue gas cyclone separator 19 for further separation, thus clean gas is obtained and discharged out of the catcher through the exhaust port, while the solid amine adsorbent separated through the primary separator 21 and the flue gas cyclone separator 19 is settled under the action of gravity and finally falls into the collecting dense phase section 22.

The solid amine adsorbent in the collecting dense phase section 22 is fluidized by the fluidization of air entering through the distribution loop pipe 23 and the air inlet 24. Then a part of the fluidized solid amine adsorbent enters the desorber 2 through the first solid amine outlet to desorb the solid amine adsorbent from CO₂; the other part enters the adsorbent inlet through the adsorbent outlet to realize the reuse of the solid amine adsorbent.

A specific structure of the treatment chamber is disclosed here. The core of the structure is to set up a structure capable of separating solid and gas in a closed housing, and to discharge the solid and the gas separately by gravity. Therefore, any structure based on this can be applied in this solution, and is within the scope of protection.

In a specific embodiment, a cross-sectional area of the above-mentioned settling section 20 is 2-10 times that of the collecting dense phase section 22, and the settling section 20 and the collecting dense phase section 22 are connected by an inclined section which tapers from the settling section 20 to the collecting dense phase section 22. Thus arrangement can facilitate the gathering and collection of the solid amine adsorbent separated from the gas and the fluidization of the solid amine adsorbent, and improve the utilization rate. The specific size of the collecting dense phase section 22 can be set according to different needs, and is not specifically limited here.

In this application, the adsorbent outlet is communicated with the adsorbent inlet through a circulating pipe 25, and the circulation pipe 25 is provided with a circulation pipe slide valve 27 for controlling the on-off of the circulation pipe 25. By setting the circulation pipe 25 and the circulation pipe slide valve 27, the solid amine adsorbent discharged from the collecting dense phase section 22 can be controlled to ensure matching with the amount of flue gas entering the flue gas inlet. In practice, because the apparatus for absorbing, capturing and desorbing CO₂ using solid amine is a large-scale apparatus, and it is difficult to operate manually and the labor intensity is high, the circulating pipe slide valve 27 can be an electric valve and connected with the control system. During operation, the amount of flue gas entering the flue gas inlet can be detected by a flow sensor, and the corresponding amount of solid amine adsorbent at 50° C. to 60° C. can be obtained by calculation, so as to control the operation of the circulating pipe slide valve 27 to ensure the amount of solid amine adsorbent entering the adsorbent inlet.

In a further embodiment, the above-mentioned desorber 2 comprises a desorber housing, a heat exchanger and a desorber cyclone separator 1. The desorber housing is provided with the second solid amine inlet and the second solid amine outlet; and the heat exchanger is provided in the desorber housing and used for heating and desorbing the solid amine adsorbent adsorbed with CO₂; the above-mentioned desorber cyclone separator 1 is used for separating CO₂ from the solid amine adsorbent, and the desorber cyclone separator 1 is provided in the desorber housing.

During operation, the spherical solid amine adsorbent is delivered to the bubbling bed desorption process by gravity. The temperature of the solid amine adsorbent is increased under the action of the heat exchanger, specifically, it can be heated to 80° C. to 110° C. and desorbed for 3 min to 10 min, so that CO₂ is desorbed from the solid amine adsorbent, and then discharged after being separated by the desorber cyclone separator 1, and these CO₂ can produce 95% CO₂ products. The solid amine adsorbent at 80° C. to 110° C. is delivered to the cooling process under the action of gravity.

CO₂ can be desorbed from the spherical solid amine adsorbent by desorption of desorber 2, which is beneficial to the reuse of CO₂ and solid amine adsorbent, reduces the emission of waste gas, saves costs, and can also achieve profit growth by reuse.

In a preferred embodiment, the above-mentioned heat exchanger comprises a serpentine heating coil 4, a steam inlet 3 and a condensing water drain outlet 5. The serpentine heating coil 4 is provided in the desorber housing, and the heat exchange area can be increased by adopting the serpentine heating coil 4 to ensure the heat exchange effect.

When in use, steam enters the serpentine heating coil 4 through the steam inlet 3 and flows in the heating coil 4. During the flow, the steam exchanges heat with the solid amine adsorbent adsorbed with CO₂, so that the temperature of the solid amine adsorbent with lower temperature increases, and the desorption of the solid amine adsorbent and CO₂ is completed during the temperature increase. During this process, temperature of the steam in the serpentine heating coil 4 decreases due to heat exchange to form condensing water, and the condensing water is discharged through the condensing water drain outlet 5.

In order to ensure the flow direction of the steam and the condensing water, in this application, the height of steam inlet 3 is set higher than that of condensing water drain outlet 5 so that the flow direction of condensing water can be guided and the problem of condensing water backflow can be prevented.

In a further embodiment, the desorber 2 disclosed above is a bubbling bed. Specifically, the desorber housing is provided with a CO₂ inlet for supplying CO₂ into the desorber housing and a CO₂ distributor 6 for distributing the supplied CO₂, and the CO₂ inlet is communicated with the CO₂ distributor, so that CO₂ passes through the CO₂ inlet and then uniformly distributed by the CO₂ distributor 6 to realize the uniform entry of CO₂.

When in use, self-produced CO₂ gas enters from the CO₂ distributor 6, 0.2 MPa(g) to 0.6 MPa(g) steam enters the serpentine heating coil 4 from the steam inlet 3, and the condensing water is discharged from the condensing water drain outlet 5. The source of CO₂ can be the CO₂ separated after desorbed from the desorber. Using CO₂ as the fluidized medium can reduce the introduction of impurities in the desorption process, increase the concentration of desorbed CO₂, and create conditions for producing high-purity CO₂ products.

In a further embodiment, the second solid amine inlet disclosed above is communicated with the first solid amine outlet through an upper connecting pipe 13. The upper connecting pipe 13 is provided with an upper slide valve 14 for controlling the on-off of the upper connecting pipe 13. The height of the first solid amine outlet is higher than that of the second solid amine inlet, and the height of the second solid amine inlet is higher than that of the second solid amine outlet; the height of the desorber 2 is higher than that of the collecting dense phase section 22 and lower than that of the settling section 20.

By connecting the second solid amine inlet with the first solid amine outlet through the upper connecting pipe 13, and setting the upper slide valve 14 for controlling the on-off of the upper connecting pipe 13, it is convenient to control the amount of solid amine adsorbent flowing from the catcher to the desorber. In order to make the solid amine adsorbent enter the desorber 2 under the action of gravity without additional power equipment, in this application, the height of the first solid amine outlet is set higher than that of the second solid amine inlet, so that the solid amine adsorbent can slide into the desorber 2 under the action of gravity.

As can be seen from the above-mentioned embodiments, in order to reduce labor intensity and realize automatic control, the upper slide valve 14 can be set as an electric valve, and the on-off of the electric valve is controlled in conjunction with a controller. In addition, the control process of the controller needs to be set in combination with the storage amount of the solid amine adsorbent.

On the basis of the above-mentioned technical solutions, the cooler 15 disclosed in this application comprises a cooler housing and a serpentine cooling pipe 17. The cooler housing is a basis for installation and connection of the whole cooler, and shape and size of the cooler housing are not limited here. Specifically, the cooler housing is provided with the above-mentioned third solid amine inlet and the third solid amine outlet, and a top of the cooler housing is provided with an exhaust pipe 7 communicated with an exhaust port of the settling section 20. The above-mentioned serpentine cooling pipe 17 is provided inside the cooler housing, and the cooler housing is provided with a cooling water outlet 16 and a cooling water inlet 18 communicated with the serpentine cooling pipe 17, and a height of the cooling water inlet 18 is lower than that of the cooling water outlet 16.

During operation, the temperature of the solid amine adsorbent passing through the desorber 2 is higher, it is necessary to cool the heated solid amine adsorbent in order to ensure that it can reach the condition of reuse. Therefore, the desorbed solid amine adsorbent is discharged into the cooler housing, and is heat exchanged with the solid amine adsorbent through the serpentine cooling pipe 17, to achieve cooling of the solid amine adsorbent, so that it finally reaches a required temperature, for example, about 40° C.

Adoption of the serpentine cooling pipe 17 can prolong the flowing distance of the cooling liquid, increase the heat exchange area and ensure the heat exchange effect. Setting the height of the cooling water inlet 18 to be lower than the height of the cooling water outlet 16 can make the cooling water flow from the lower end to the upper end, realize the countercurrent heat exchange of the cooling water and the solid amine adsorbent, and improve the heat exchange effect. It can be understood by those skilled in the art that other ways of heat exchange and cooling can also be adopted in practice, and are all within the scope of protection.

In a further embodiment, the above-mentioned cooler 15 further comprises an air inlet 9 and an air distribution pipe 10. The air inlet 9 is provided on the cooler housing and used for providing air into the cooler housing. The air distribution pipe 10 is communicated with the air inlet 9, and the air distribution pipe 10 is an annular pipe provided along the circumferential direction of the cooler housing, and the annular pipe are uniformly provided with air outlets. By providing the air inlet 9 and the air distribution pipe 10, fluidized air can enter the cooler 15 from the air inlet 9 and the air distribution pipe 10. On this basis, the cooling water at 10° C. to 20° C. enters from the cooling water inlet 18, and is discharged from the cooling water outlet 16 after countercurrent heat exchange with the solid amine adsorbent through the three-section vertically connected serpentine cooling pipe 17, and the heat exchange time is 5 min to 30 min, thus completing the whole heat exchange process. The solid amine adsorbent is cooled to 40° C. and discharged from the bottom, and the fluidized air in the cooler 15 is discharged from the top to the upper part of the settling section 20 through the exhaust pipe 7, and finally discharged through the exhaust port.

By using air as the fluidizing medium, no new impurities can be introduced, thus ensuring the purity of the solid amine adsorbent.

In a specific embodiment, the third solid amine outlet of the above-mentioned cooler 15 is communicated with the first solid amine inlet through a connecting pipe 11, and the connecting pipe 11 is provided with a connecting pipe slide valve 12 for controlling the on-off of the connecting pipe 11, and a height of the third solid amine outlet is greater than that of the first solid amine inlet; the third solid amine inlet of the cooler 15 is communicated with the second solid amine outlet through a lower connecting pipe 8, and the height of the second solid amine outlet is greater than that of the third solid amine inlet, the height of the third solid amine inlet is higher than that of the serpentine cooling pipe 17, and the height of the third outlet is lower than that of the serpentine cooling pipe 17.

The third solid amine outlet and the first solid amine inlet are communicated through the connecting pipe 11 and controlled through the connecting pipe slide valve 12, which can realize the control of the position of the solid amine adsorbent according to different work requirements. As can be seen from the above-mentioned embodiments, the connecting pipe slide valve 12 can be an electric valve, and at the same time, it is in signal connection with the controller.

Similarly, the third solid amine inlet and the second solid amine outlet of the cooler 15 are communicated through the lower connecting pipe 8, and the height of the second solid amine outlet is greater than that of the third solid amine inlet, so as to realize the flow of the solid amine adsorbent under the action of gravity without driving, which reduces the cost and simplifies the structure.

The height of the third solid amine inlet is higher than that of the serpentine cooling pipe 17, and the height of the third outlet is lower than that of the serpentine cooling pipe 17, so as to prolong the contact time of the solid amine adsorbent and the serpentine cooling pipe 17 and ensure the cooling effect.

In a specific embodiment, a height of the delivery pipe 26 disclosed in this application can be set to 30 m to 50 m, the settling section 20 is provided at a position with a height of 45 m to 60 m, the desorber 2 is provided at a position with a height of 30 m to 50 m, and the cooler housing has a height of 8 m to 20 m and is provided at a position with a height of 15 m to 35 m. The delivery pipe 26 passes through the collecting dense phase section 22 and extends into the settling section 20. In conclusion, a height of the cooler 15 is lower than that of the desorber 2 and lower than that of the catcher.

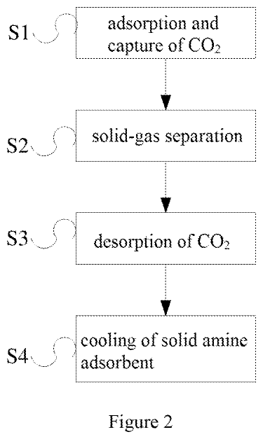

In addition, as shown in FIG. 2, a method for absorbing, capturing and desorbing CO₂ using solid amine is also disclosed in the invention. Specifically, the method comprises the following steps:

### Step S1: Adsorption and Capture of CO₂.

The flue gas is introduced into the delivery pipe using a fan, and the spherical solid amine adsorbent is fluidized in the delivery pipe, wherein in the delivery pipe, a temperature is 30° C. to 40° C., a pressure is 70 kPa(a) to 120 kPa(a), a solid-gas ratio is 2 to 30, a gas flow rate is 2 m/s to 20 m/s, and a contact time of the flue gas being mixed with the solid amine adsorbent is 3 s to 20 s, to complete adsorption and capture of CO₂.

### Step S2: Solid-Gas Separation.

The solid amine adsorbent adsorbed and captured with CO₂ is delivered to a top end of the delivery pipe, and gas-solid separation is completed in a flue gas cyclone separator in a settling chamber at a top end of the delivery pipe. The gas is discharged through an exhaust port, and the solid amine adsorbent settles to a collection dense phase section, and a part of the solid amine adsorbent is delivered to the delivery pipe to enter the next cycle.

### Step S3: Desorption of CO₂.

The settled solid amine adsorbent is delivered to the desorber by gravity, CO₂ desorbed last time is introduced into the desorber as a fluidizing agent for fluidizing the solid amine adsorbent, and the solid amine adsorbent is heated by a heat exchanger of a bubbling bed. When the solid amine adsorbent is heated to 80° C. to 110° C. and desorbed for 3 min to 10 min, CO₂ is desorbed from the spherical adsorbent.

### Step S4: Cooling of the Solid Amine Adsorbent.

The desorbed high-temperature solid amine adsorbent is delivered from the desorber to the cooler by gravity, and fluidized by air and cooled for 5 min to 30 min through a serpentine cooling tube to obtain a solid amine adsorbent at 40° C., which is delivered to the delivery pipe to enter the next cycle.

In the above-mentioned method, the high-speed delivery pipe has high mass transfer speed and high capture efficiency of CO₂; in addition, it relies on its own gravity to complete the cycle process of desorption, cooling and delivery to the delivery pipe. In the process, the equipment is simple, the concentration of CO₂ in the flue gas is reduced from 10% to 15% to 1% to 5%, and the CO₂ product with 99% concentration can be produced, making it suitable for capture of CO₂ in large-scale industrial flue gas.

The various embodiments in this specification are described in a progressive manner. Each of the embodiments is mainly focused on describing its differences from other embodiments, and references may be made among these embodiments with respect to the same or similar parts.

According to the above-mentioned description of the disclosed embodiments, those skilled in the art can implement or practice the present invention. Many modifications to these embodiments are apparent for those skilled in the art, and general principles defined herein may be implemented in other embodiments without departing from the spirit or scope of the present invention. Therefore, the present invention will not be limited to the embodiments disclosed herein, but has the widest scope in accordance to the principle and the novel features disclosed herein.

1. An apparatus for absorbing, capturing and desorbing CO₂ using solid amine, comprising:
a catcher used for capturing CO₂ in flue gas and comprising a treatment chamber for adsorbing CO₂ in the flue gas by means of a spherical solid amine adsorbent and a delivery pipe communicated with the treatment chamber, a bottom end of the delivery pipe being provided with a flue gas inlet, a first solid amine inlet and an adsorbent inlet, and an adsorbent outlet of the treatment chamber being communicated with the adsorbent inlet;
a desorber for heating and desorbing CO₂ adsorbed by the solid amine adsorbent, a second solid amine inlet of the desorber being communicated with a first solid amine outlet of the catcher; and
a cooler for cooling the solid amine adsorbent treated by the desorber, a third solid amine inlet of the cooler being communicated with a second solid amine outlet of the desorber, and a third solid amine outlet of the cooler being communicated with the first solid amine inlet of the catcher.

2. The apparatus for absorbing, capturing and desorbing CO₂ using solid amine according to claim 1, wherein in the delivery pipe, a temperature is 30° C. to 40° C., a pressure is 70 kPa(a) to 120 kPa(a), a solid-gas ratio is 2 to 30, a gas flow rate is 2 m/s to 20 m/s, and a contact time of the flue gas being mixed with the solid amine adsorbent is 3 s to 20 s.

3. The apparatus for absorbing, capturing and desorbing CO₂ using solid amine according to claim 1, wherein the treatment chamber comprises the follow sections along the delivery direction of materials in the delivery pipe in sequence:
a collecting dense phase section provided with an air inlet for fluidizing air to enter and a distribution loop pipe communicated with the air inlet, the distribution loop pipe being uniformly provided with air outlets in a circumferential direction, and the first solid amine outlet and the adsorbent outlet being provided on the collecting dense phase section and below the distribution loop pipe and the air inlet;
a settling section communicated with the collecting dense phase section and used for settling the solid amine adsorbent for capturing CO₂; a top end of the delivery pipe being provided with a primary separator for separating the flue gas from the solid amine adsorbent, an outlet of the primary separator being located at the settling section, and the settling section being provided with a flue gas cyclone separator for separating flue gas treated by the primary separator, and a top of the settling section being provided with an exhaust port for discharging the treated flue gas.

4. The apparatus for absorbing, capturing and desorbing CO₂ using solid amine according to claim 3, wherein a cross-sectional area of the settling section is 2-10 times that of the collecting dense phase section, and the settling section and the collecting dense phase section are connected by an inclined section tapering from the settling section to the collecting dense phase section.

5. The apparatus for absorbing, capturing and desorbing CO₂ using solid amine according to claim 3, wherein the adsorbent outlet is communicated with the adsorbent inlet through a circulating pipe, and the circulating pipe is provided with a circulating pipe slide valve for controlling the on-off of the circulating pipe.

6. The apparatus for absorbing, capturing and desorbing CO₂ using solid amine according to claim 3, wherein, the desorber comprises:
a desorber housing provided with the second solid amine inlet and the second solid amine outlet;
a heat exchanger provided in the desorber housing and used for heating and desorbing the solid amine adsorbent adsorbed with CO₂;
a desorber cyclone separator provided in the desorber housing and used for gas-solid separation.

7. The apparatus for absorbing, capturing and desorbing CO₂ using solid amine according to claim 6, wherein the heat exchanger comprises:
a serpentine heating coil provided in the desorber housing;
a steam inlet and a condensing water drain outlet provided on the desorber housing and communicated with the serpentine heating coil, and the height of the steam inlet being higher than that of the condensing water drain outlet.

8. The apparatus for absorbing, capturing and desorbing CO₂ using solid amine according to claim 6, wherein the desorber is a bubbling bed, and the desorber housing is provided with a CO₂ inlet for supplying CO₂ into the desorber housing and a CO₂ distributor for distributing the supplied CO₂, and the CO₂ inlet is communicated with the CO₂ distributor.

9. The apparatus for absorbing, capturing and desorbing CO₂ using solid amine according to claim 6, wherein the second solid amine inlet is communicated with the first solid amine outlet through an upper connecting pipe provided with an upper slide valve for controlling the on-off of the upper connecting pipe, and a height of the first solid amine outlet is higher than that of the second solid amine inlet, and a height of the second solid amine inlet is higher than that of the second solid amine outlet;
a height of the desorber is higher than that of the collecting dense phase section and lower than that of the settling section.

10. The apparatus for absorbing, capturing and desorbing CO₂ using solid amine according to claim 3, wherein the cooler comprises:
a cooler housing provided with the third solid amine inlet and the third solid amine outlet, and a top of the cooler housing being provided with an exhaust pipe communicated with an exhaust port of the settling section;
a serpentine cooling pipe provided in the cooler housing, the cooler housing being provided with a cooling water outlet and a cooling water inlet communicated with the serpentine cooling pipe, and a height of the cooling water inlet is lower than that of the cooling water outlet.

11. The apparatus for absorbing, capturing and desorbing CO₂ using solid amine according to claim 10, wherein the cooler further comprises:
an air inlet provided on the cooler housing and used for supplying air into the cooler housing;
an air distribution pipe communicated with the air inlet, the air distribution pipe being an annular pipe arranged along a circumferential direction of the cooler housing, and the annular pipe being uniformly provided with air outlets.

12. The apparatus for absorbing, capturing and desorbing CO₂ using solid amine according to claim 10, wherein the third solid amine outlet of the cooler is communicated with the first solid amine inlet through a connecting pipe provided with a connecting pipe slide valve for controlling the on-off of the connecting pipe, and a height of the third solid amine outlet is greater than that of the first solid amine inlet;
the third solid amine inlet of the cooler is communicated with the second solid amine outlet through a lower connecting pipe, and a height of the second solid amine outlet is greater than that of the third solid amine inlet, and a height of the third solid amine inlet is higher than that of the serpentine cooling pipe, and a height of the third outlet is lower than that of the serpentine cooling pipe.

13. The apparatus for absorbing, capturing and desorbing CO₂ using solid amine according to claim 12, wherein a height of the cooler is lower than that of the desorber.

14. A method for absorbing, capturing and desorbing CO₂ using solid amine, comprising the following steps:
adsorption and capture of CO₂: introducing a flue gas into a delivery pipe using a fan, and fluidizing spherical solid amine adsorbent in the delivery pipe, wherein in the delivery pipe a temperature is 30° C. to 40° C., a pressure is 70 kPa(a) to 120 kPa(a), a solid-gas ratio is 2 to 30, a gas flow rate is 2 m/s to 20 m/s, and a contact time of the flue gas being mixed with the solid amine adsorbent is 3 s to 20 s, to complete adsorption and capture of CO₂;
solid-gas separation: delivering the solid amine adsorbent adsorbed and captured with CO₂ to a top end of the delivery pipe, and completing gas-solid separation in a flue gas cyclone separator in a settling chamber at a top end of the delivery pipe, discharging the gas through an exhaust port, the solid amine adsorbent settling to a collecting dense phase section, and delivering a part of the solid amine adsorbent to the delivery pipe to enter the next cycle;
desorption of CO₂: delivering the settled solid amine adsorbent to a desorber by gravity, introducing CO₂ desorbed last time into the desorber as a fluidizing agent for fluidizing the solid amine adsorbent, and heating the solid amine adsorbent using a heat exchanger of a bubbling bed, and when the solid amine adsorbent is heated to 80° C. to 110° C. and desorbed for 3 min to 10 min, desorbing CO₂ from the spherical adsorbent; and
cooling of the solid amine adsorbent: delivering the desorbed high-temperature solid amine adsorbent from the desorber to the cooler by gravity, and fluidizing by air and cooling for 5 min to 30 min through a serpentine cooling pipe to obtain a solid amine adsorbent at 40° C., and delivering the solid amine adsorbent to the delivery pipe to enter the next cycle.
